(19) United States
(12) Patent Application Publication
(10) Pub. No.: US 2025/0137884 A1
(43) Pub. Date: May 1, 2025

(54) VEHICLE SUPPORT FOR A CHASSIS TEST BENCH AND METHOD FOR EQUIPPING A CHASSIS TEST BENCH WITH SUCH A VEHICLE SUPPORT

(71) Applicant: AVL List GmbH, Graz (AT)

(72) Inventor: Georg SEEWALD, Graz (AT)

(73) Assignee: AVL List GmbH, Graz (AT)

(21) Appl. No.: 18/835,037

(22) PCT Filed: Jan. 31, 2023
(86) PCT No.: PCT/AT2023/060021

§ 371 Date: Aug. 1, 2024

(30) Foreign Application Priority Data
Feb. 1, 2022 (AT) A 50049/2022

(51) Int. Cl. G01M 17/007

(52) U.S. Cl. CPC G01M 17/007

(57) ABSTRACT

Test benches are known on which vehicles have to be brought in on lifting platforms or independently and prepared for connection to the load apparatus.

In order to shorten the existing setting-up time and dismantling time on the test bench, the use of a vehicle support (10) for a chassis test bench (80) with two longitudinal supports (12, 14), a connecting apparatus via which the two longitudinal supports (12, 14) are connected to each other, supporting plates (56), of which first supporting plates (56) are arranged on the first longitudinal support (12) and second supporting plates (56) are arranged on the second longitudinal support (14), and adapter devices (62) which are arranged on the supporting plates (56) and serve to provide a connection between a wheel hub (64) of a vehicle (60) and a load apparatus (66) is suggested, wherein at least two wheels (78) are mounted on each longitudinal support (12, 14) by means of which the vehicle support (10) can be moved.

The invention relates to a vehicle support for a chassis test bench and a method for equipping a chassis test bench with such a vehicle support.

Chassis test benches usually have a device for generating a load, in particular a drive torque, torsional moment or load torque, which is then transferred to a hub of a motor vehicle via an adapter device. These adapter devices are usually first attached to the hub of the motor vehicle, which must first be correctly positioned in relation to the test apparatus. Since a correct positioning of the hub of the vehicle in relation to the test apparatus in all three spatial axes is necessary here, this is often difficult, given that the vehicle is no longer drivable after the adapter devices have been fitted.

This problem is, for example, addressed by WO 2017/013173 A1. The test apparatus disclosed here has a load apparatus that can be moved in the direction of the vehicle's axis via a rail. The vehicle is lifted onto a lifting platform, where the connection of the adapter device to the wheel hubs of the vehicle can be established. The vehicle can then also be aligned with the load apparatus in the height direction by means of the lifting platform. However, the orientation of the vehicle in the direction of travel remains problematic. Accordingly, the vehicle must either be driven into an optimal position in this respect before lifting, or expensive lifting platforms that can be moved in the direction of travel must be used as vehicle supports.

The equipping of these test benches is correspondingly complex. Above all, however, the time required to dismantle such a test bench, for example in an emergency, is far too long.

The object is therefore to provide a vehicle support for a chassis test bench as well as a method for equipping a chassis test bench with such a vehicle support with which the setting-up time and the dismantling time can be shortened and a simplification of the connection of the vehicle being tested to the load apparatus made possible.

This object is achieved by a vehicle support for a chassis test bench with two longitudinal supports which are connected to each other via a connecting apparatus. Supporting plates are arranged on the two longitudinal supports, namely first supporting plates on the first longitudinal support and second supporting plates on the second longitudinal support. In particular, the number of these supporting plates is four, whereby the number corresponds to the number of wheel hubs of the vehicle, so that when testing a car, a supporting plate is in each case arranged at the front and rear of the first longitudinal support and a supporting plate is also in each case arranged opposite at the front and rear of the second longitudinal support. An adapter device is positioned on each of the supporting plates, which serves to provide a connection between a wheel hub of the vehicle and a load apparatus, so that the torque applied by the load apparatus is transferred to the wheel hub of the vehicle via the adapter device. At least two wheels are mounted on each of the two longitudinal supports by means of which the vehicle support can be moved. Usually, one of the wheels on each longitudinal support is arranged further forward and one of the wheels is arranged further back. However, a greater number of wheels can be chosen depending on the weight of the vehicles to be transported. With such a vehicle support, it is therefore possible to carry out the preparation of the vehicle at a distance from the test bench. Here, the adapter devices can already be mounted on the wheel hubs and the vehicle with the adapter devices can be set down on the supporting plates. The vehicle prepared in this way can then be positioned in relation to the chassis test bench with the moveable vehicle support. This simplifies the connection to the load apparatus and greatly reduces the setting-up time on the test bench. This can also improve the utilisation of the test bench. Furthermore, in an emergency, the vehicle can be removed from the test bench with the vehicle support, for which purpose only the connection between the load apparatus and the adapter devices needs to be released. Accordingly, the necessary dismantling time is significantly shortened, so that the vehicle can be quickly removed from the test bench even in emergencies.

This object is also achieved by a method for equipping a chassis test bench with such a vehicle support in which a vehicle which is to be tested is first lifted using a permanently installed lifting platform. In this state, the wheels are freely accessible, so that the adapter devices can be mounted on wheel hubs of the vehicle. The vehicle support is then placed under the vehicle, for example by means of a driven vehicle shifter. The vehicle support is either pulled or pushed by the vehicle shifter and rolls off on its wheels. A self-propulsion of the vehicle support is also conceivable. The vehicle support is adjusted with regard to its track width and wheelbase to correspond to the track width and wheelbase of the vehicle, either beforehand or in its position under the vehicle, so that the vehicle, with the adapter devices, can subsequently be lowered onto supporting plates of the vehicle support and is thus firmly positioned on the vehicle support. The vehicle support with the vehicle can then be driven to the chassis test bench by means of the vehicle shifter or independently, and the adapter devices can be connected, on the chassis test bench, to a load apparatus for testing. The test can then be carried out. Accordingly, the vehicle can be brought to the test bench, already prepared, in the shortest possible time, so that no further setting-up time is required on the test bench itself, with the exception of establishing the connection between the adapter devices and the load apparatus. Furthermore, the vehicle support allows the vehicle to be easily aligned with respect to the load apparatus and quickly removed from the test bench.

In an advantageous embodiment of the invention, the connecting apparatus can be designed as a linkage.

Preferably, at least one supporting plate on the first longitudinal support and at least one supporting plate on the second longitudinal support, which are arranged opposite each other, are arranged moveably on the respective longitudinal support. In a vehicle support with two supporting plates per longitudinal support, this means that either the two front supporting plates or the two rear supporting plates or all four supporting plates are guided moveably on the longitudinal supports. Accordingly, the distance between these supporting plates on the longitudinal support can be adjusted to match the wheelbase of the vehicle. Furthermore, constructive means of securing the supporting plates with the longitudinal supports in transport can be provided in order to meet country-specific safety requirements for transport.

Furthermore, it is advantageous if the supporting plates are surrounded by a frame and are arranged on a base of the frame. Accordingly, it is possible to decouple the supporting plates from the frame and its base. In addition, the frame prevents the adapter device and the vehicle from moving beyond the frame, so that accidents can be avoided.

In a further preferred embodiment, the supporting plates with the frames can be moved on rails of the longitudinal support. Accordingly, the supporting plates can be driven indirectly via the frame, so that this is again decoupled from the loaded supporting plate. The rails can be formed both on top of the longitudinal supports as well as laterally, so that the frame encloses the longitudinal support and is guided there.

The supporting plates are preferably driven on the rails via the frame by means of an electric motor. This is easily electrically controllable and allows quick and accurate adjustment to adapt the position of the supporting plate to the vehicle's wheelbase.

Vibration decoupling between the supporting plates and the rest of the vehicle support, and thus between the drive and the frame, is advantageously achieved in that damping elements are arranged on the undersides of the supporting plates facing the longitudinal supports. These can for example be made of an elastomer and allow slight movements of the supporting plate in relation to the frame, which is necessary in particular when testing on the load apparatus.

In a particularly inexpensive and easy-to-install embodiment, the damping elements rest on the base of the frame or are attached thereto.

In order to ensure complete decoupling of the supporting plate and thus the adapter device from the frame, and thus from the rest of the vehicle support, a gap is formed on all sides between the frame and the supporting plate arranged therein, as result of which vibrations of the supporting plate also cannot be transmitted to the frame laterally.

Preferably, the adapter device has a lower bearing plate to which ball casters are attached with which the bearing plate rests on the supporting plate. Thus, at least slight movements of the adapter device on the supporting plate in two axis directions are possible. This makes it easier to connect the adapter device to the load apparatus, since minor corrections between the axes can be easily made.

Furthermore, it is preferable if the connecting apparatus can be extended and contracted between the longitudinal supports. As a result of such contraction and extension, the distance between the two longitudinal supports is adjusted, so that in this case the vehicle support can be adjusted to the correct track width of the vehicle to be tested. Such a movement can be carried out on the one hand by telescopically retractable linkage rods or by cross rods whose individual rods are rotated relative to each other. As an alternative to a linkage, other connecting apparatus such as cross members arranged perpendicular to the longitudinal supports can also be used which are preferably also retractable.

Accordingly, the connecting apparatus for connecting the two longitudinal supports is preferably designed as a diagonal bracing. Such a diagonal bracing ensures high stability and at the same time ensures that the two longitudinal supports remain aligned parallel to each other.

In a further embodiment, the diagonal bracing comprises at least two rods which are connected to each other by a centrally arranged joint, wherein in each case a first end of each rod is connected to the first longitudinal support and a second end of each rod is connected to the second longitudinal support and, in order to contract or extend the connecting apparatus, one rod can be rotated relative to the other rod via the joint. Thus, only one drive is required, since the rods only have to be rotated relative to each other on the common axis of rotation in order to adjust the track [width].

In a further development of the invention, the diagonal bracing comprises four rods, two of which are arranged on top of each other and are firmly connected to each other, wherein the centrally arranged joint is designed as a mounted shaft via which the first two rods are connected to each other in the middle, and wherein the shaft is mounted in a sleeve via which the second two rods are connected to each other in the middle, so that the two first rods can be rotated relative to the two second rods, creating a movement of the longitudinal supports towards or away from each other. This design of the diagonal bracing achieves a high level of stability.

This rotation is also preferably carried out by an electric motor, which allows very precise adjustment.

Preferably, the second end of the first rod or of the first two rods and the first end of the second rod or of the second two rods are guided moveably on the longitudinal support. This means that one end of the rod, for example the front end, is firmly mounted on the longitudinal supports, while the opposite end is moveable on the longitudinal supports to allow the distance between the longitudinal supports to be adjusted.

Furthermore, it is advantageous if the two rods arranged on top of each other are connected to each other at their first ends and second ends by axles which are mounted rotatably on the longitudinal supports. Such a rotation is required in order to adjust the track width and is very easy to achieve through the mounting of the two axles.

Thus, a vehicle support for a chassis test bench as well as a method for equipping a chassis test bench with such a vehicle support is provided with which the setting-up times, in particular on the test bench itself, can be significantly shortened, since mobility of the vehicle is achieved and an almost complete preliminary set-up can take place outside the test bench. An adaptation of the vehicle support to the respective vehicle to be tested can be carried out very simply and quickly. Thus, for the first time, the testing of a vehicle can be carried out directly on a vehicle support, which can also be used to remove the vehicle from the test bench very quickly in an emergency.

A non-restrictive exemplary embodiment of a vehicle support for a chassis test bench according to the invention is described in the following with reference to the figures, as is the method for equipping a test bench with such a vehicle support.

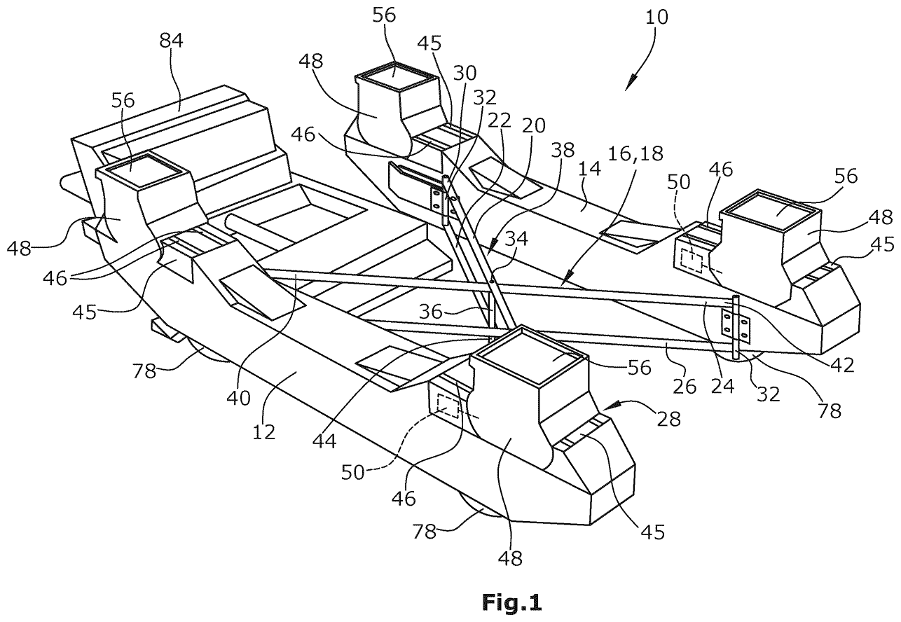

FIG. 1 shows a perspective view of a vehicle support according to the invention and a vehicle shifter

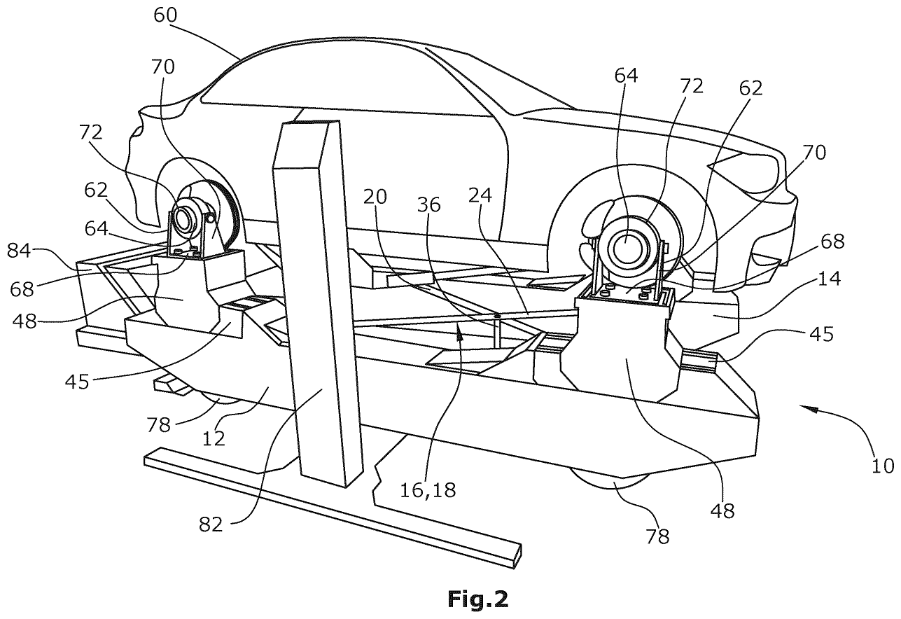

FIG. 2 shows the vehicle support according to the invention from FIG. 1 as the vehicle is being set in place.

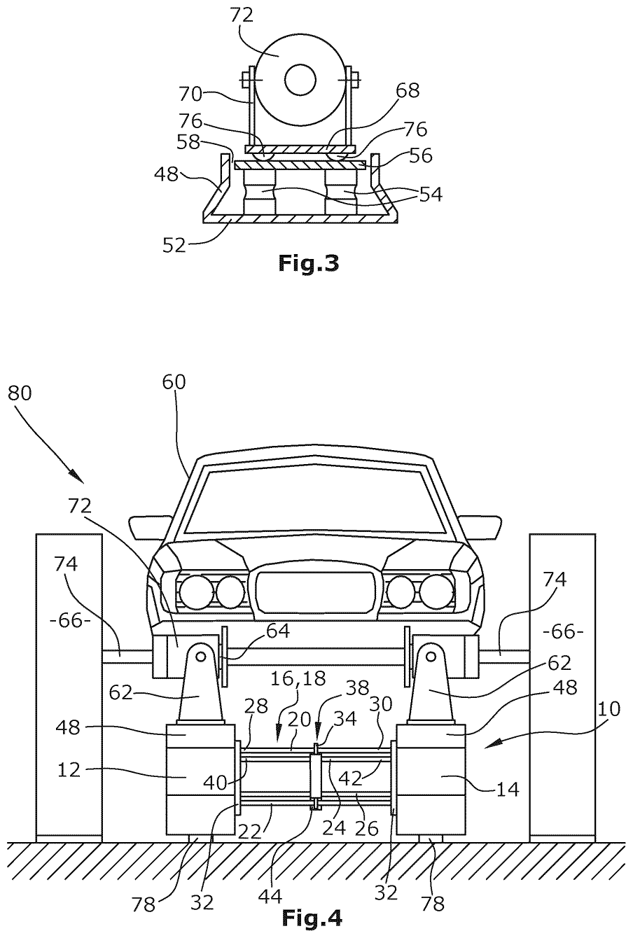

FIG. 3 shows a side view of a frame of the vehicle support according to the invention with adapter attached.

FIG. 4 shows a front view of the vehicle support with the vehicle on the test bench

The vehicle support 10 according to the invention has a first longitudinal support 12 and a second longitudinal support 14 which are aligned parallel to each other.

For this purpose, the two longitudinal supports 12, 14 are connected via a connecting apparatus designed in the form of a linkage 16, whereby the linkage 16 is designed as a diagonal bracing 18. The diagonal bracing 18 consists of a total of four rods 20, 22, 24, 26, of which the first two rods 20, 22 are arranged parallel to each other, on top of each other, and are connected to each other at their two ends 28, 30 via axles 32. The first two rods 20, 22 are connected to each other in the middle by a shaft 34 which is mounted in a sleeve 36 via which the other two rods 24, 26 are connected to each other, so that the sleeve 36 and the two second rods 24, 26 are arranged within the first two rods 20, 22. The shaft 34 with the sleeve 36 forms a centrally arranged joint 38 of the diagonal bracing 18. The second two rods 24, 26 are also connected to each other at their two ends 40, 42 via an axle 32.

The first end 28 of the first two rods 20, 22 is attached rotatably to the first longitudinal support 12 via the axle 32. The opposite second end 30 of the first two rods 20, 22 is mounted moveably and rotatably on the second longitudinal support 14. The first end 40 of the second two rods 24, 26 is also attached moveably and rotatably to the first longitudinal support 12, opposite to the second end 30 of the first two rods 20, 22. The second end 42 of the second two rods 24, 26 is, correspondingly, attached rotatably to the second longitudinal support 14 opposite to the first end 28 of the first two rods 20, 22. An electric motor 44 engages with the shaft 34, and is suitable for rotating the shaft 34 relative to the sleeve 36, as a result of which the first two rods 20, 22 can be rotated relative to the second rods 24, 26, which leads to the two longitudinal supports 12, 14 being pulled towards each other or pushed away from each other, whereby the first end 40 of the second rods 24, 26 and the second end 30 of the first rods 20, 22 can be displaced on the longitudinal supports 12, 14, while the opposite ends 28, 42 of the rods 20, 22, 24, 26 rotate on the longitudinal supports 12, 14. Accordingly, a track width of the vehicle support 10 can be adjusted by actuating the electric motor 44.

Two mounting areas 45 are formed at the front and rear of each longitudinal support 12, 14 which comprise two parallel rails 46 on which frames 48 are guided. These four frames 48 are mounted on the rails 46 and can be moved along the rails 46 in the direction of extension of the longitudinal supports 12, 14 by an electric motor 50.

Each of these frames 48 has a base 52 to which four damping elements 54 in the form of elastomers are attached, as can be seen in FIG. 3. In each frame 48, a supporting plate 56 is arranged on the four damping elements 54 which is surrounded by a gap 58 between the sides and the frame 48, so that there is a vibration decoupling of the supporting plate 56 from the frame 48. Accordingly, two first supporting plates 56 are arranged in a sliding manner on the first longitudinal support 12, at the front and rear, and two second supporting plates 56 are arranged on the second longitudinal support 14, at the front and rear. The number of supporting plates 56 corresponds to the number of wheels of a vehicle 60 to be tested. The supporting plates 56 can accordingly be moved with the frames 48 along the rails 46, so that the distance can be adjusted to the wheelbase of the vehicle 60.

To test such a vehicle 60, this needs to be set down on the supporting plates 56. For this purpose, an adapter device 62 is first attached to a wheel hub 64 of the vehicle 60 in the familiar way, serving as an intermediate piece between a load apparatus 66 designed to introduce a torque to the wheel axles of the vehicle 60 and the wheel hubs 64.

This adapter device 62 can be seen in FIG. 3. It has a lower bearing plate 68 carrying a bearing block 70 on which a rotating mounting 72 is mounted which can be connected to the wheel hub 64 of the vehicle 60 and on the opposite side to a drive axle 74 of the load apparatus 66.

Four ball casters 76 are formed on the lower side of the bearing plate 68, with which the adapter device 62 is placed on the supporting plate 56, which make it possible to move the adapter device 62 on the supporting plate 56, in this plane, at least up to the edge of the frame 48. In this way, internal stresses on the chassis caused by setting the vehicle 60 down on the vehicle support 10 can be prevented, as the adapter devices 62 can align at least slightly with respect to the vehicle support 10.

According to the invention, at least four wheels 78 are mounted rotatably on the longitudinal supports 12, 14, by means of which the vehicle support can be moved. Usually, on each of the longitudinal supports 12, 14 there is a wheel 78 in the front area and a wheel 78 in the rear area, so that the vehicle support 10 is completely connected to the workshop floor via the wheels 78.

Accordingly, the setting-up of a vehicle 60 for a chassis test bench 80 can be carried out outside of the chassis test bench 80 itself.

This is done in that the vehicle 60 is first driven to a known permanently installed lifting platform 82 and lifted by the lifting platform 82. The vehicle wheels can then be removed and the adapter devices 62 can be connected to the wheel hubs 64. This can be done in a workshop outside of the chassis test bench 80.

The vehicle support 10 is now driven under the vehicle 60, either by means of a driven vehicle shifter 84 or, if self-propulsion means are installed, independently. The wheels 78 arranged on the longitudinal supports 12, 14 are used for this purpose. By operating the electric motors 44, 50, the distance between the longitudinal supports 12, 14 and the distance between the frames 48 on the longitudinal supports 12, 14 can be adjusted so that the supporting plates 56 are arranged exactly beneath the lower bearing plates 68 of the adapter devices 62. The vehicle is then lowered onto the vehicle support so that the adapter devices 62 rest on the supporting plates 56 with the ball casters 76. A securing bracket, not shown, which secures the adapter devices 62 on the supporting plate 56 against rotation, is now preferably also folded over the adapter devices.

The vehicle support 10 with the vehicle 60 is then brought to the chassis test bench and aligned to the drive axle 74 of the load apparatus 66. The adapter device 62 is then connected to the load apparatus 66 so that the chassis tests can be carried out. In the event of a sudden emergency, the vehicle with the vehicle support can be quickly removed from the test bench, since this only requires the connection to the load apparatus 66 to be released.

With this vehicle support, vehicles with particularly high hub heights can also be tested without any problems, since fans and other systems can be placed under the vehicle. In particular, however, better utilisation of the test benches is possible, since set-up and dismantling times on the test bench are significantly shortened.

It should be clear that the invention is not limited to the described exemplary embodiment, but that a large number of design modifications of the moveable vehicle support are possible.

1. Vehicle support for a chassis test bench with two longitudinal supports,
a connecting apparatus via which the two longitudinal supports are connected to each other,
supporting plates, of which first supporting plates are arranged on the first longitudinal support and second supporting plates are arranged on the second longitudinal support,
adapter devices which are arranged on the supporting plates and serve to provide a connection between a wheel hub of a vehicle and a load apparatus,
wherein at least two wheels are mounted on each longitudinal support by means of which the vehicle support can be moved.

2. Vehicle support for a chassis test bench according to claim 1,
wherein
the connecting apparatus is designed as a linkage.

3. Vehicle support for a chassis test bench according to claim 1,
wherein
a supporting plate on the first longitudinal support and a supporting plate on the second longitudinal support, which are arranged opposite each other, are arranged moveably on the respective longitudinal support.

4. Vehicle support for a chassis test bench according to claim 1,
wherein
the supporting plates are surrounded by a frame and are arranged on a base of the frame.

5. Vehicle support for a chassis test bench according to claim 4,
wherein
the supporting plates with the frames can be moved on rails of the longitudinal support.

6. Vehicle support for a chassis test bench according to claim 5,
wherein
the supporting plates are driven on the rails via the frame by means of an electric motor.

7. Vehicle support for a chassis test bench according to claim 1,
wherein
damping elements are arranged on the undersides of the supporting plates facing the longitudinal supports.

8. Vehicle support for a chassis test bench according to claim 7,
wherein
the damping elements rest on the base of the frame.

9. Vehicle support for a chassis test bench (80) according to claim 4,
wherein
a gap is formed on all sides between the frame and the supporting plate arranged therein.

10. Vehicle support for a chassis test bench according to claim 1,
wherein
the adapter device has a lower bearing plate to which ball casters are attached with which the bearing plate rests on the supporting plate.

11. Vehicle support for a chassis test bench according to claim 1,
wherein
the connecting apparatus between the longitudinal supports can be extended and contracted.

12. Vehicle support for a chassis test bench according to claim 1,
wherein
the connecting apparatus for connecting the two longitudinal supports is designed as a diagonal bracing.

13. Vehicle support for a chassis test bench according to claim 12,
wherein
the diagonal bracing comprises at least two rods which are connected to each other by a centrally arranged joint, wherein in each case a first end of each rod is connected to the first longitudinal support and a second end of each rod is connected to the second longitudinal support and, in order to contract or extend the connecting apparatus, one rod can be rotated relative to the other rod via the joint.

14. Vehicle support for a chassis test bench according to claim 12,
wherein
the diagonal bracing comprises four rods, two of which are in each case arranged on top of each other and are firmly connected to each other, wherein the centrally arranged joint is designed as a mounted shaft via which the first two rods are connected to each other in the middle, wherein the shaft is mounted in a sleeve via which the second two rods are connected to each other in the middle, so that the two first rods can be rotated relative to the two second rods.

15. Vehicle support for a chassis test bench according to claim 13,
wherein
the rotation is carried out by an electric motor.

16. Vehicle support for a chassis test bench according to claim 13,
wherein
the second end of the first rod or of the first two rods and the first end of the second rod or of the second two rods are guided moveably on the longitudinal supports.

17. Vehicle support for a chassis test bench according to claim 16,
wherein
the two rods arranged on top of each other are connected to each other at their first ends and second ends by axles which are mounted rotatably on the longitudinal supports.

18. Method for equipping a chassis test bench with a vehicle support according to claim 1,
in which
a vehicle is lifted by means of a permanently installed lifting platform,
adapter devices are mounted on the wheel hubs of the vehicle,
the vehicle support is placed under the vehicle,
the vehicle support is adjusted with regard to its track width and wheelbase to correspond to the track width and wheelbase of the vehicle,
the vehicle with the adapter devices is lowered onto supporting plates of the vehicle support,
the vehicle support is driven with the vehicle to the chassis test bench,
the adapter devices can be connected, on the chassis test bench, to a load apparatus for testing.
